(19) United States
(12) Patent Application Publication
(10) Pub. No.: US 2008/0043706 A1
(43) Pub. Date: Feb. 21, 2008

(54) METHOD AND APPARATUS FOR CONTROLLING TRANSMISSION OF A CHANNEL QUALITY INDICATOR

(75) Inventor: Alexander Reznik, Titusville, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/839,186

(22) Filed: Aug. 15, 2007

Related U.S. Application Data
(60) Provisional application No. 60/837,691, filed on Aug. 15, 2006.

(51) Int. Cl. H04B 7/212

(52) U.S. Cl. 370/347

(57) ABSTRACT

A method and apparatus for controlling transmission of a channel quality indicator (CQI) in a wireless communication system are disclosed. A wireless transmit/receive unit (WTRU) determines, at each transmission time interval (TTI), whether a CQI timer has expired. The CQI timer is reset each time a CQI is sent out by the WTRU. If the CQI timer has expired, the WTRU determines whether a CQI reporting opportunity exists in a current TTI. The WTRU sends a CQI if a CQI reporting opportunity exists in the current TTI. Otherwise, the WTRU waits for a next TTI. The CQI reporting opportunity exists when there is uplink data to be transmitted in the current TTI, when the WTRU needs to send a positive acknowledgement (ACK) or a negative acknowledgement (NACK) in the current TTI, or when a dedicated physical control channel (DPCCH) burst is scheduled to be transmitted in the current TTI.

### CROSS REFERENCE TO RELATED APPLICATION

This application claims the benefit of U.S. provisional application No. 60/837,691 filed Aug. 15, 2006, which is incorporated by reference as if fully set forth.

### FIELD OF INVENTION

The present invention is related to wireless communication systems. More particularly, the present invention is related to a method and apparatus for controlling transmission of a channel quality indicator (CQI) in a wireless communication system.

### BACKGROUND

Recent improvements on the wideband code division multiple access (WCDMA) frequency division duplex (FDD) radio access standard for universal mobile telecommunication systems (UMTS) have introduced high speed packet access (HSPA) operation in the downlink (in Release 5) and in the uplink (Release 6). Through Release 6, the third generation partnership project (3GPP) standards require user equipment (UE) to support circuit-switched operation and dedicated channels in a physical layer. There are two primary reasons for this. First, voice calls are traditionally handled by a circuit-switched network and require dedicated channel support. Second, control information in a radio resource control (RRC) “connected state,” (i.e., the CELL_DCH state), is mapped onto dedicated control channels.

With the advent of voice over Internet protocol (VoIP) and recent developments which allow VoIP to be deployed over a packet-switched wireless network, support of voice calls over a circuit-switched network is no longer necessary. Additionally, there is no compelling reason why control data cannot be sent over shared packet-switched physical channels. In fact, due to the intermittent nature of the control data, packet-switched channels are better suited to carry the control data than “always-on” dedicated channels designed for circuit-switched operation. In addition, there are significant system capacity and performance advantages in using packet-switched operation as opposed to circuit-switched operation.

One aspect in which a packet-only UE can significantly improve network performance is reduction of interference caused by control channel transmissions in the uplink. The 3GPP continuous packet connectivity (CPC) study addressed this issue by proposing gating of the uplink dedicated physical control channel (DPCCH). However, an uplink DPCCH is not the only uplink control channel which causes interference in the uplink. Another source of uplink interference is a high speed dedicated physical control channel (HS-DPCCH). The HS-DPCCH is used to carry two portions of information essential for high speed downlink packet access (HSDPA) operation: 1) a positive acknowledgement (ACK) or a negative acknowledgement (NACK) in response to data transmitted in the downlink; and 2) a CQI which is used by a Node-B scheduler to schedule a data rate, a modulation and coding scheme (MCS) for downlink packets to the UE, or the like.

While the ACK/NACK transmissions occur only when necessary, (i.e., when there was downlink data sent and an ACK or a NACK is required), the CQI transmissions are currently scheduled by RRC signaling and may occur at time intervals not connected to any other events, (i.e., the CQI transmissions may occur regardless of DPCCH gating, ACK/NACK feedback, or the like).

The CQI transmissions may contribute unnecessary interference in the uplink. Additionally, the CQI transmissions may force the UE to turn its transmitter on when there is no other reason to do so. This, while not impacting the system capacity, affects the power efficiency and battery life of the UE.

### SUMMARY

The present invention is related to a method and apparatus for controlling transmission of a CQI in a wireless communication system. A wireless transmit/receive unit (WTRU) determines, at each transmission time interval (TTI), whether a CQI timer has expired. The CQI timer is reset each time a CQI is sent out by the WTRU. If the CQI timer has expired, the WTRU determines whether a CQI reporting opportunity exists in a current TTI. The WTRU sends a CQI if a CQI reporting opportunity exists in the current TTI. Otherwise, the WTRU waits for a next TTI. The CQI reporting opportunity exists when there is uplink data to be transmitted in the current TTI, when the WTRU needs to send an ACK or a NACK in the current TTI, or when a DPCCH burst is scheduled to be transmitted in the current TTI.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is a block diagram of a WTRU in accordance with the present invention; and

FIG. 2 is a flow diagram of a process of controlling transmission of a CQI in accordance with the present invention.

### DETAILED DESCRIPTION OF THE PREFERRED EMBODIMENTS

When referred to hereafter, the terminology “WTRU” includes but is not limited to a UE, a mobile station, a fixed or mobile subscriber unit, a pager, a cellular telephone, a personal digital assistant (PDA), a computer, or any other type of user device capable of operating in a wireless environment. When referred to hereafter, the terminology “Node-B” includes but is not limited to a base station, a site controller, an access point (AP), or any other type of interfacing device capable of operating in a wireless environment.

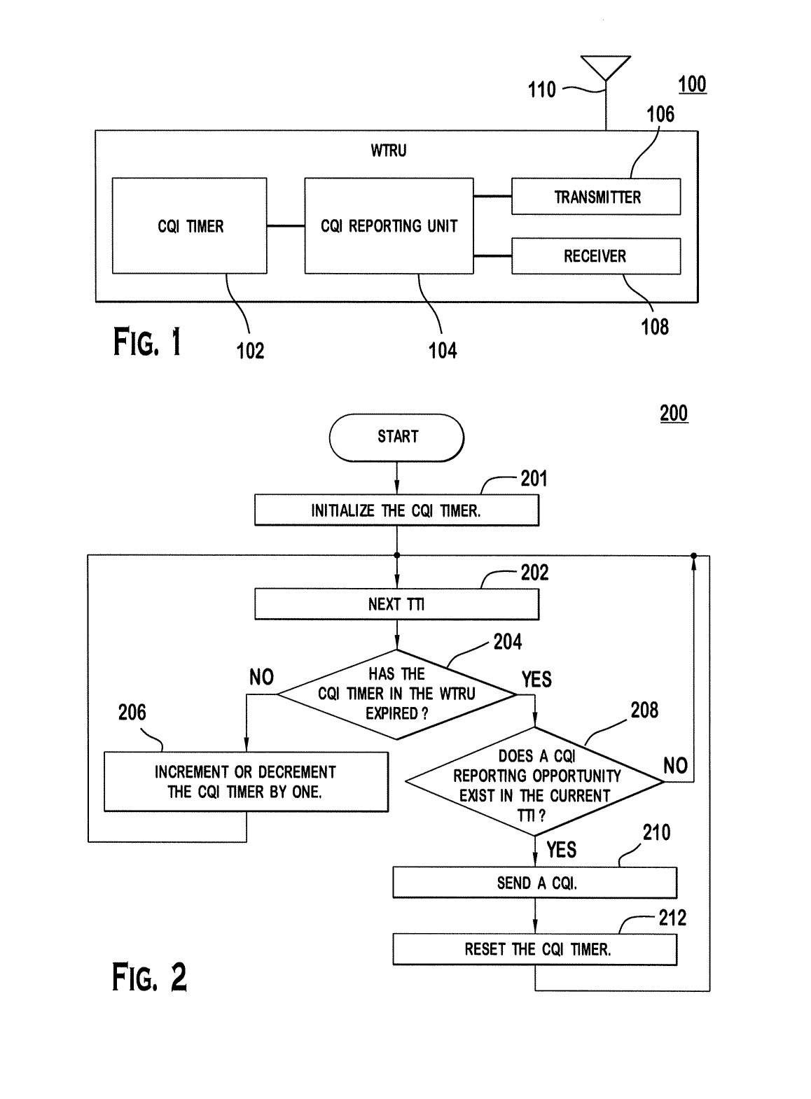

FIG. 1 is a block diagram of a WTRU 100 in accordance with the present invention. The WTRU 100 includes a CQI timer 102, a CQI reporting unit 104, a transmitter 106, a receiver 108 and at least one antenna 110. The CQI timer 102 is used to track the time period for sending a CQI. The CQI timer 102 is reset each time a CQI is sent out by the WTRU 100. The CQI reporting unit 104 sends a CQI via the transmitter to a Node-B when the CQI timer 102 expires and a CQI reporting opportunity exists in a current TTI, which will be explained in detail hereinafter. The transmitter 106, the receiver 108 and the antenna 110 are standard components of the WTRU 100 so that they will not be explained in detail for simplicity. It should be noted that FIG. 1 is a simplified block diagram of a WTRU 100 and the WTRU 100 may include many other conventional components for processing signals and messages.

Conventionally, a regular CQI reporting time is configured by the parameter CQI_REPORT_INT, which is configured via RRC signaling. In accordance with the present invention, during periods of packet inactivity, the CQI reporting is performed less frequently with a minimal impact to the conventional RRC signaling.

FIG. 2 is a flow diagram of a process 200 of controlling transmission of a CQI in accordance with the present invention. At the start of the process 200, the CQI timer is initialized (step 201). At the next TTI (step 202), the CQI reporting unit 104 determines whether a CQI timer 102 has expired (step 204). The CQI timer 102 is reset every time the WTRU 100 sends a CQI to a Node-B. The parameter CQI_REPORT_INT is still configured by the RRC signaling. The CQI timer 102 is incremented by one (1), (or any other relevant value), every TTI, and considered to be expired if the CQI timer value is equal to or greater than the CQI_REPORT_INT value. Alternatively, the CQI timer 102 may be initialized to the CQI-REPOTR_INT value and decremented by one (1) every TTI, and considered to be expired when it reaches zero (0).

If the CQI timer 102 has not expired, the CQI timer 102 is incremented, (or alternatively decremented), by one (1), (or any other relevant value), at step 206 and the process 200 returns to step 202 to wait for the next TTI. If the CQI timer 102 has expired, the CQI reporting unit 104 determines whether a CQI reporting opportunity exists in a current TTI (step 208). The CQI reporting opportunity exists if there is a gated DPCCH burst scheduled to be transmitted in the current TTI, if an ACK/NACK needs to be sent in the current TTI, or when there is uplink data to be transmitted in the current TTI.

If a CQI reporting opportunity does not exist in the current TTI, the process 200 returns to step 202 to wait for the next TTI. If a CQI reporting opportunity exists in the current TTI, the CQI reporting unit 104 sends a CQI to the Node-B via an uplink control channel, (e.g., HS-DPCCH), (step 210). After sending the CQI, the CQI timer is reset (step 212), and the process 200 returns to step 202 to wait for the next TTI.

In accordance with the present invention, the interference on uplink channel due to CQI transmissions is effectively minimized since the CQI reporting is performed only if there is another uplink transmission, (e.g., DPCCH burst, ACK/NACK, uplink data, or the like).

The present invention has an impact on the Node-B scheduler because the Node-B scheduler may not receive the CQI continuously. However, the impact is not serious. For example, when uplink DPCCH gating is implemented so that the WTRU sends a DPCCH burst every DPCCH gating cycle, (DPCCH_CYCLE), if the CQI_REPORT_INT is equal to or less than the DPCCH_CYCLE, a CQI report is available every DPCCH_CYCLE sub-frame because a CQI report is sent with every DPCCH burst, unless the CQI timer has not expired. If the CQI_REPORT_INT is greater than the DPCCH_CYCLE, the delay between two reports will not be greater than 2×CQI_REPORT_INT. Because the delay between two (2) reports is equal to the sum of two delay: CQI_REPORT_INT and a delay associated with waiting for a reporting opportunity, if the reporting opportunity delay is not larger than the DPCCH_CYCLE, which is itself smaller than CQI_REPORT_INT, the total delay is not larger than 2×CQI_REPORT_INT.

The Node-B scheduler will have a current CQI report available after sending just one downlink transmission to the WTRU because if CQI reporting is due, a CQI will be sent together with an ACK/NACK in response to the downlink transmission. Thus, even if the Node-B scheduler does not have a current CQI for accurate scheduling, the lack of current CQI is corrected after the first transmission.

The first transmission should not be a serious problem for short uplink discontinuous transmission (DTX) cycles. In long uplink DTX cycles, the Node-B scheduler may use two different strategies with regard to the first transmission. In accordance with one embodiment, the Node-B scheduler may maximize the chances that the first transmission is successfully delivered, (e.g., by using a lower data rate and/or a lower order MCS, and the like). In this case, the Node-B scheduler slowly backs off from the most recent resource allocation towards the lowest possible. In accordance with another embodiment, the Node-B scheduler uses the opposite strategy. The Node-B scheduler allocates lowest possible radio resources for the first transmission assuming that a NACK is likely. The Node-B scheduler then slowly increases the resource allocation from the last resource allocation. Alternatively, the Node-B scheduler may do nothing.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method of controlling transmission of a channel quality indicator (CQI) from a wireless transmit/receive unit (WTRU) in a wireless communication system, the method comprising:
(a) the WTRU determining, at each of a plurality of transmission time intervals (TTIs), whether a CQI timer has expired, the CQI timer being reset each time a CQI is sent out by the WTRU;
(b) if the CQI timer has expired, the WTRU determining whether a CQI reporting opportunity exists in a current TTI; and
(c) the WTRU sending a CQI and resetting the CQI timer if a CQI reporting opportunity exists in the current TTI.

2. The method of claim 1 wherein the CQI reporting opportunity exists when there is uplink data to be transmitted in the current TTI.

3. The method of claim 1 wherein the CQI reporting opportunity exists when the WTRU needs to send a positive acknowledgement (ACK) or a negative acknowledgement (NACK) in the current TTI.

4. The method of claim 1 wherein the CQI reporting opportunity exists when a dedicated physical control channel (DPCCH) burst is scheduled to be transmitted in the current TTI.

5. The method of claim 1 wherein the CQI timer is set to a value set via radio resource control (RRC) signaling.

6. The method of claim 1 wherein the CQI is sent via a high speed dedicated physical control channel (HS-DPCCH).

7. The method of claim 1 wherein the WTRU is provided only with a shared channel and the CQI is sent via the shared channel.

8. The method of claim 1 further comprising:
if it is determined at step (a) that the CQI timer has not expired, the WTRU incrementing the CQI timer; and
returning to step (a).

9. The method of claim 1 further comprising:
if it is determined at step (b) that the CQI reporting opportunity does not exist in the current TTI, returning to step (a).

10. A wireless transmit/receive unit (WTRU) for controlling transmission of a channel quality indicator (CQI) in a wireless communication system, the WTRU comprising:
a CQI timer, the CQI timer being reset each time a CQI is sent out; and
a CQI reporting unit configured to determine, at each of a plurality of transmission time intervals (TTIs), whether the CQI timer has expired, if the CQI timer has expired further determine whether a CQI reporting opportunity exists in a current TTI, and if a CQI reporting opportunity exists in the current TTI, send a CQI and reset the CQI timer.

11. The WTRU of claim 10 wherein the CQI reporting opportunity exists when there is uplink data to be transmitted in the current TTI.

12. The WTRU of claim 10 wherein the CQI reporting opportunity exists when the WTRU needs to send a positive acknowledgement (ACK) or a negative acknowledgement (NACK) in the current TTI.

13. The WTRU of claim 10 wherein the CQI reporting opportunity exists when a dedicated physical control channel (DPCCH) burst is scheduled to be transmitted in the current TTI.

14. The WTRU of claim 10 wherein the CQI timer is set to a value set via radio resource control (RRC) signaling.

15. The WTRU of claim 10 wherein the CQI is sent via a high speed dedicated physical control channel (HS-DPCCH).

16. The WTRU of claim 10 wherein the WTRU is provided only with a shared channel and the CQI is sent via the shared channel.

17. The WTRU of claim 10 wherein the CQI reporting unit is further configured to increment the CQI timer if it is determined that the CQI timer has not expired in the current TTI.
